(19) United States
(12) Patent Application Publication
(10) Pub. No.: US 2016/0223008 A1
(43) Pub. Date: Aug. 4, 2016

(54) SCREW

(71) Applicants: MING-CHIA CHENG, KAOHSIUNG CITY (TW); KUN-MU HUANG, KAOHSIUNG CITY (TW)

(72) Inventors: MING-CHIA CHENG, KAOHSIUNG CITY (TW); KUN-MU HUANG, KAOHSIUNG CITY (TW)

(21) Appl. No.: 14/608,456

(22) Filed: Jan. 29, 2015

(51) Int. Cl. F16B 25/10

(52) U.S. Cl. CPC F16B 25/103

(57) ABSTRACT

A screw includes a shank with a threaded section extending downwards from a head. A drilling portion is connected to the shank. The drilling portion includes a first body having a point and a conical second body between the first body and the shank. The first body has two opposite and flat first surfaces. Each first surface is connected to a second surface and a third surface. The third surface slopes down from the second surface to the point. Each first surface forms a groove meeting the second surface and the third surface along a cutting edge. A distance between the two first surfaces is ¼˜¾ times a shank diameter. Thus, the effect of accommodating and removing chips and the strength of the first body are promoted. The chips leaving each groove are moved along the second body and then removed to attain a smooth and labor-saving operation.

### BACKGROUND OF THE INVENTION

1. Field of the Invention

This invention relates to a screw and relates particularly to a screw for fastening a wood board to a metal floor structure of a container or for fastening any wood board to a metal board.

2. Description of the Related Art

A container, e.g. a shipping container, a cargo container and a container house, is usually constructed by a metal floor board, and a wooden board is usually laid on and secured to the metal board of the container. Generally, a container screw is a wood-metal screw whereby the boards are fastened together, so the container screw should be able to cut both the wooden board and the metal board to suit the demand. For example, FIG. 1 and FIG. 2 show a conventional container screw 1 including a head 11, a shank 12 extending downwards from the head 12, a threaded section 13 spirally disposed on the shank 12, a drill 14 installed at an end of the shank 12, and two wings 15 disposed on the drill 14. The end of the shank 12 forms a slot 121 where a top part of the drill 14 is embedded. The drill 14 has two opposite flat surfaces so that the drill 14 can have a flat shape. A thickness 14D between the two opposite flat surfaces of the drill 14 is less than ⅕ times a diameter 12D of the shank 12. During the manufacturing process, the top part of the flat drill 14 is directly inserted into the slot 121, and then the end of the shank 12 is compressed with a tool (not shown) to lodge the top part of the drill 14 into the slot 121. In use, the drill 14 is rotated to bore a hole on a wooden board and a metal board of a container (not shown). During the drilling action, the threaded section 13 keeps drilling into the boards while the wings 15 are reaming the hole. Thus, the wooden board is fastened to the metal board by the screw 1.

Generally, a method of making the screw 1 comprises steps of forming the shank 12 and the drill 14 respectively, embedding the drill 14 into the slot 121 and lodging the top part of the drill 14 in the slot 121 by gripping and compressing the end of the shank 12 with a tool. Such method requires many detailed steps and takes time, so the manufacturing cost is high. Further, the thickness 14D less than ⅕ the diameter 12D may render the drill 14 thinner to take more wood chips, but the hardness and strength of the drill 14 may not be good enough to overcome the drilling resistance. Therefore, the material of the drill 14 must be limited to one with the higher hardness, and the material cost may be increased inevitably.

FIG. 3 and FIG. 4 show another conventional container screw 2 which includes a head 21, a shank 22 extending downwards from the head 21, a threaded section 23 spirally disposed on the shank 22, an elliptical drill 24 with two opposite grooves 241 disposed at an end of the shank 22, and two wings 25 disposed on the shank 22 and between the threaded section 23 and the drill 24. When the drill 24 enters a wooden board 31 which is laid on a metal floor panel 32 of a container 3 and cuts wood fibers of the board 31 into wood chips, the chips accumulate between the drill 24 and the wings 25 easily because of lack of a proper means for removing chips. This causes the container screw 2 unable to remove the chips from the drill 24 effectively. Further, the accumulation of too many chips around the drill 24 incurs an over large drilling resistance and renders the container screw 2 unable to drill into the wooden board 31 successfully. It is also possible that the screw 2 snaps under the over large drilling resistance. Thus, the conventional screws should be improved.

### SUMMARY OF THE INVENTION

It is an object of this invention to provide a screw which increases the strength of the drilling portion and attains the preferable effect of cutting, removing and accommodating chips.

The screw in accordance with this invention comprises a head, a shank extending downwards from the head, a threaded section spirally disposed on the shank, and a drilling portion connected to the shank. The drilling portion includes a flat first body with a point and a second body with a conical surface or in a shape of a conical frustum disposed between the first body and the shank. The first body has two opposite first surfaces, two second surfaces respectively extending from the first surfaces, and two third surfaces respectively connected to the first surfaces and the second surfaces and sloping down from the second surfaces to the point. Each first surface is a flat surface and has a groove recessedly formed thereon. Each groove extends upwards from the point by an extended length and intersects with the second and the third surface along a cutting edge. A distance between the two opposite first surfaces is ¼˜¾ times a diameter of the shank. Therefore, the distance between the two flat first surfaces can be set at least ¼ times the diameter of the shank with the aid of the groove formed on each first surface in order to provide an increased thickness whereby the strength of the entire first body is promoted. The first body having the flat shape and the grooves also helps increase the space for removing and receiving the cut chips. The chips leaving each groove are moved along the second body and then removed from the wooden workpiece, thereby attaining a smooth and labor-saving operation.

Preferably, at lease one wing can protrude from the first body or the shank. In one preferred embodiment, two wings are formed on the second surface of the first body. In another preferred embodiment, two wings are formed on the shank and located close to the second body.

Preferably, the threaded section spirally disposed on the shank further extends to the conical surface of the second body.

Preferably, at least one chip clearance recess is formed on the second body.

Preferably, a neck is disposed between the second body and the first body. A maximum diameter of the neck is less than the diameter of the shank.

The advantages of this invention are more apparent to those skilled in the art upon reading following descriptions in conjunction with accompanying drawings.

### BRIEF DESCRIPTION OF THE DRAWINGS

FIG. 1 is a perspective view showing a first conventional screw;

FIG. 2 is a bottom plan view of FIG. 1;

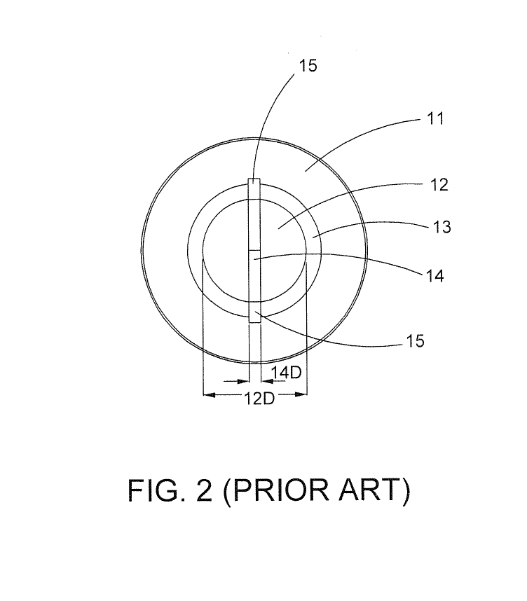

FIG. 3 is a schematic view showing a second conventional screw;

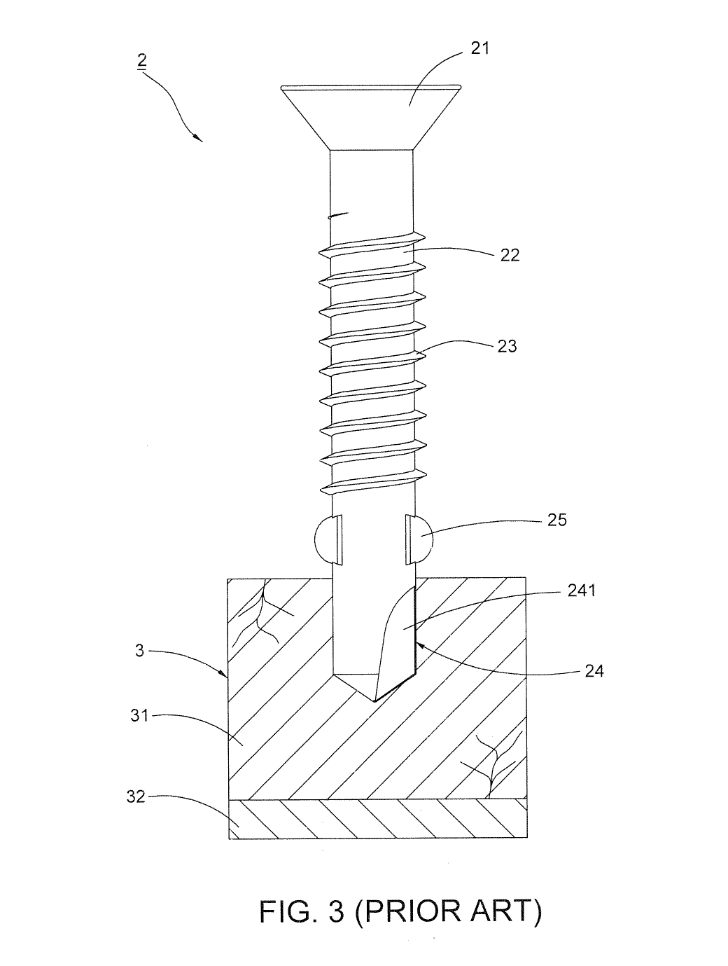

FIG. 4 is a bottom plan view of FIG. 3;

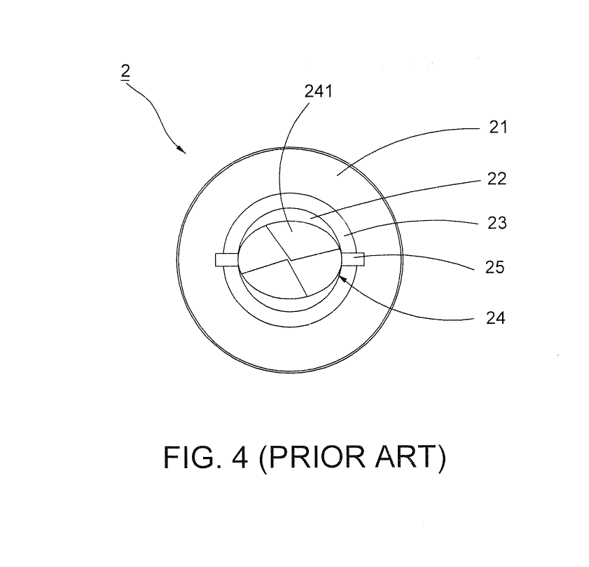

FIG. 5 is a perspective view showing a first preferred embodiment of this invention;

FIG. 6 is a bottom plan view of FIG. 5;

FIG. 7 is a schematic view showing the front elevation of FIG. 5 in use;

FIG. 8 is a schematic view showing the side elevation of FIG. 5 in use;

FIG. 9 is a perspective view showing a second preferred embodiment of this invention; and

FIG. 10 is a perspective view showing a third preferred embodiment of this invention.

### DETAILED DESCRIPTION OF THE PREFERRED EMBODIMENTS

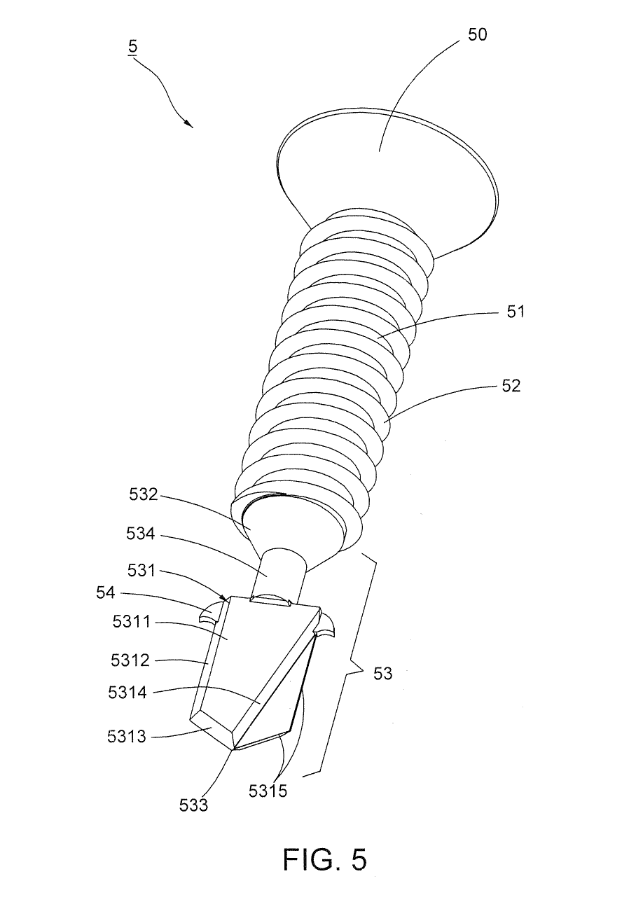

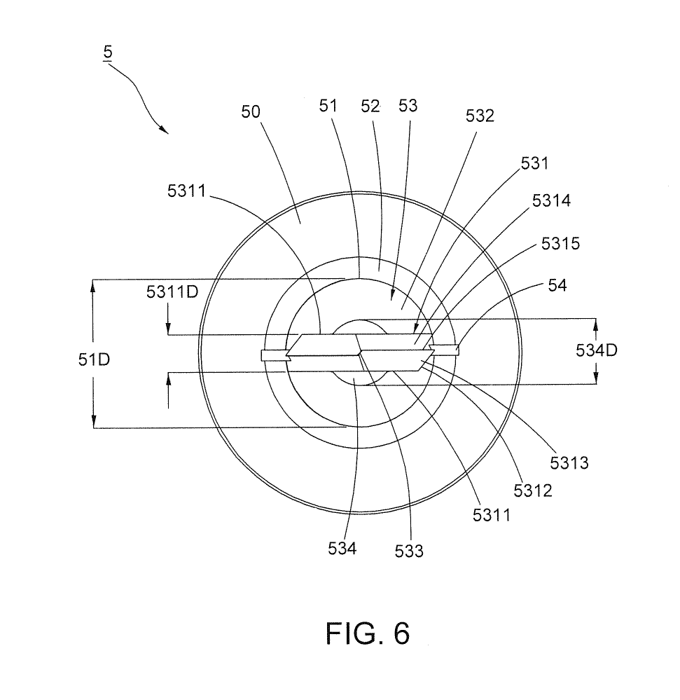

Referring to FIG. 5 and FIG. 6, a screw 3 of a first preferred embodiment of this invention comprises a head 50, a shank 51 extending downwards from the head 50, a threaded section 52 spirally disposed on the shank 51, and a drilling portion 53 connected to the shank 51. The drilling portion 53 includes a first body 531 having a point 533 and a second body 532 having a conical surface. The first body 531 is formed into a flat and elongated design. Specifically, two oppositely-disposed first surfaces 5311 are provided in opposite sides of the first body 531. Two second surfaces 5312 are respectively provided in the opposite sides of the first body 531. Herein, each second surface 5312 extends from each first surface 5311, and preferably extends rearwards from each first surface 5311 to suit a screwing direction. Two third surfaces 5313 are also provided in the opposite sides of the first body 531. Each third surface 5313 is connected to the first surface 5311 and the second surface 5312 and slopes down from the second surface 5312 to the point 533. Therefore, the two opposite third surfaces 5313 meet at the point 533. Further, each of the first surfaces 5311 is flat, and a groove 5314 is recessedly formed on each of the first surfaces 5311. The groove 5314 extends upwards and slantingly from the point 533 by an extended length and meets each of the second surfaces 5312 and each of the third surfaces 5313 along a cutting edge 5315. In addition, a distance 5311D between the two opposite first surfaces 5311 is ¼˜¾ times a diameter 51D of the shank 51. With respect to the second body 532, the second body 532 is disposed between the first body 531 and the shank 51 and has a shape of a conical frustum. Specifically, the second body 532 has a decreasing diameter from a part connected to the shank 51 to a part connected to a top portion of the first body 531 or connected to a neck 534 which will be described as follows.

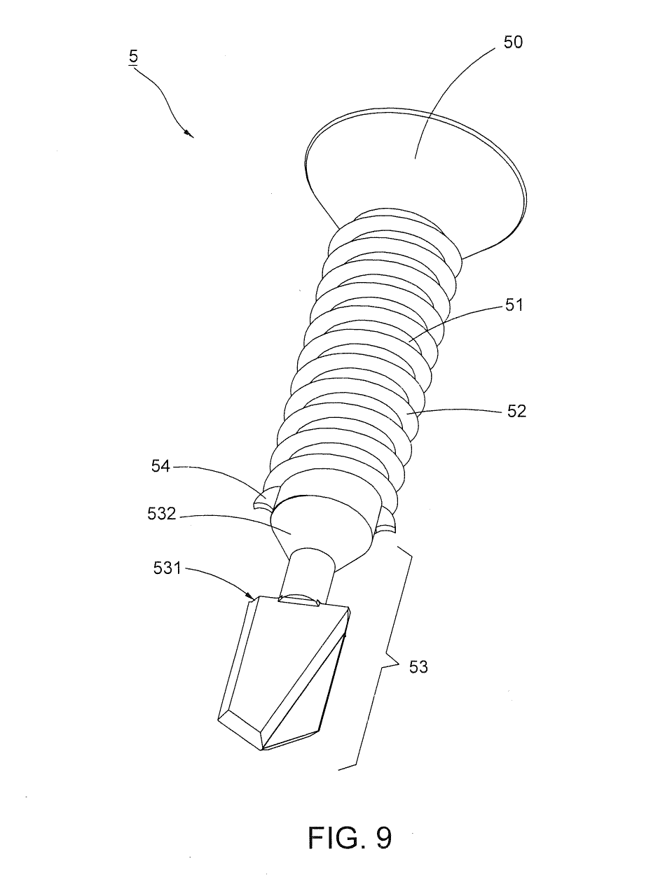

In the preferred embodiment, a neck 534 can be preferably disposed between the second body 532 and the first body 531, and a maximum diameter 534D of the neck 534 is less than the diameter 51D of the shank 51. Furthermore, at lease one wing 54 can be provided. For example, the first body 531, as shown in FIG. 5, has two wings 54 protruding from the second surface 5312. It is possible that the groove 5314 extends to where the wings 54 are located. Alternatively, FIG. 9 shows a second preferred embodiment, the wings 54 of which protrude from the shank 51 and located close to the second body 532. Herein, the structure that two wings 54 are respectively disposed on the second surfaces 5312 is described as an example.

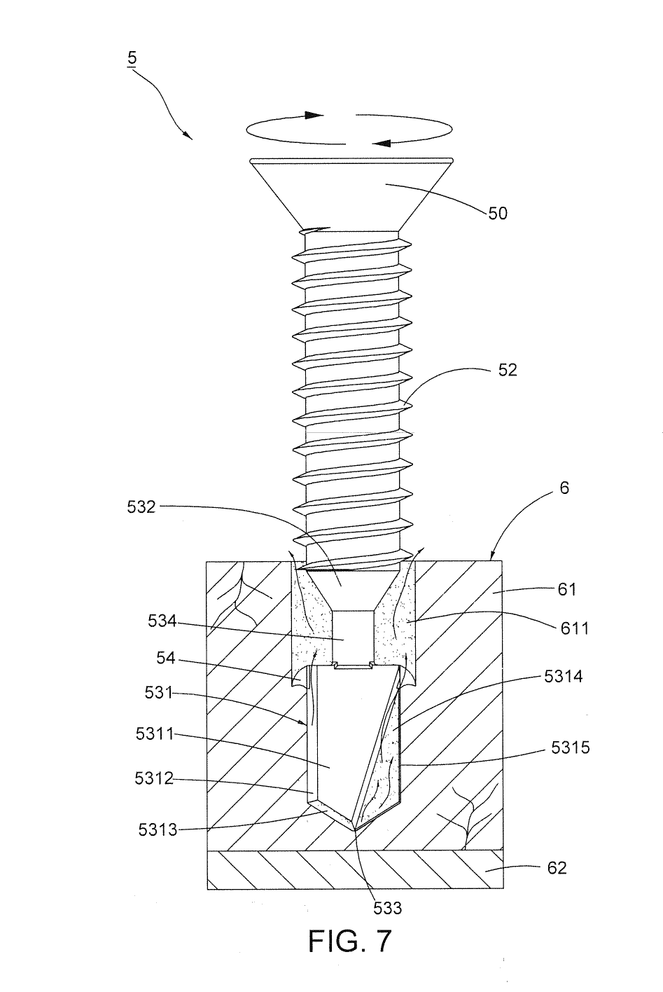

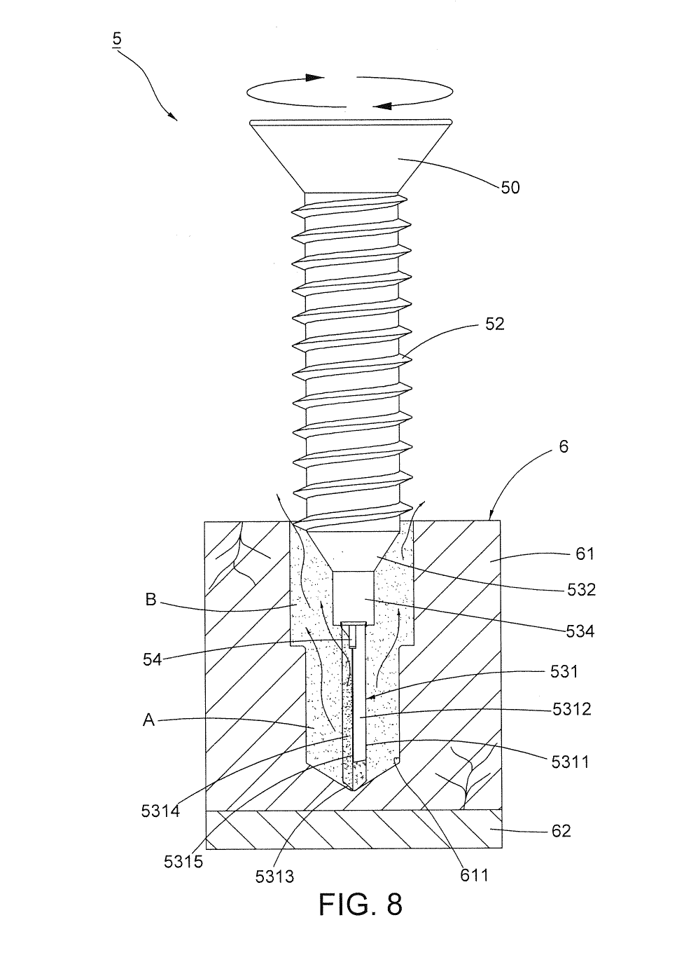

This screw 5 is used to fasten a wooden workpiece 61 to a metal workpiece 62 of a container 6, the use of which is explained with the aid of FIG. 7 and FIG. 8. Referring to FIG. 7, a user puts the point 533 on the wooden workpiece 61 and rotates the head 50 by a screwing direction to drill the first body 531 into the wooden workpiece 61. Therefore, the two opposite cutting edges 5313 bore a hole 611 in the wooden workpiece 61 and cut wood fibers. During the cutting action, the first body 531 with the flat shape and the grooves 5314, the neck 534 and the second body 532 increase the space for removing and receiving chips. In other words, a room A, as shown in FIG. 8, is formed around the first body 531 between the first surfaces 5311 which are flat and the hole 611, and a channel B communicating with the room A is also formed around the neck 534 and the second body 532 within the hole 611. The room A and the channel B allow the chips to be accommodated therein. When each cutting edge 5313 cuts the wood fibers into chips, the chips travel along each groove 5314 and enter the room A and the channel B directly because of the slantingly extending groove 5314. Thus, the cut chips are moved from each groove 5314 to the room A and the channel B quickly, and then part of the chips, as arrowed in the figures, keep moving along the second body 532 whereby the chips are expelled from the wooden workpiece 61 easily and quickly. This prevents too many chips from accumulating in the hole 611 and obstructing the drilling action of the drilling portion 53. The drilling resistance is reduced to attain a smooth and labor-saving drilling action, and the conventional snapping problem under the over large resistance is also prevented. After the screw 5 subjects the wooden workpiece 61 to the aforementioned cutting and removing action, a proper amount of remaining chips stay in the grooves 5314, the room A and the channel B, and then the cutting edges 5315 and the wings 54 continue cutting the metal workpiece 62 and reaming. Thus, the threaded section 52 can be firmly positioned into the metal workpiece 62, and the two workpieces 61, 62 are firmly fastened together with the screw 5.

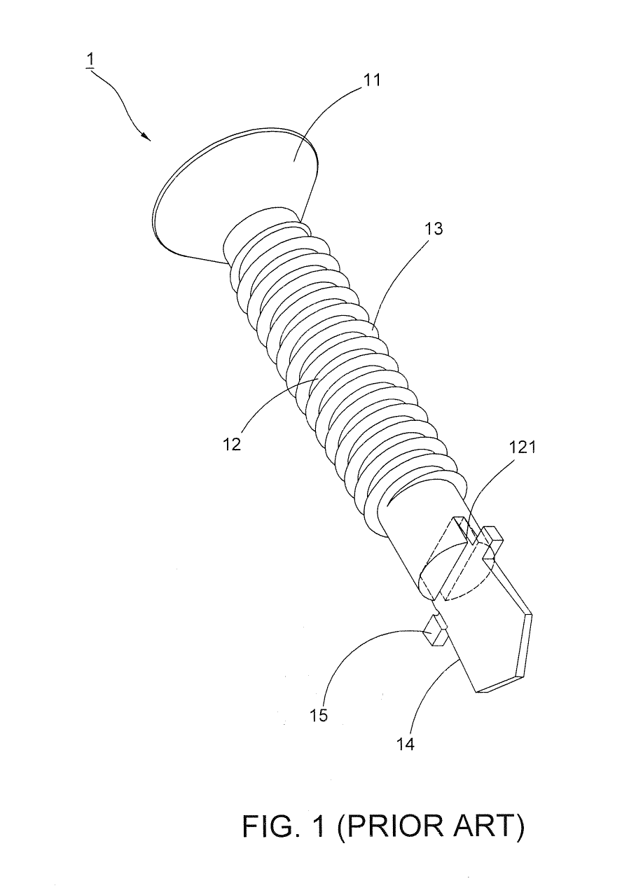

By designing the flat first body 531 with grooves 5314, the second body 532 and the neck 534, the room A and the channel B between the drilling portion 53 and the hole 611 can be largely increased to promote the effect of removing and accommodating chips and facilitate a smooth and labor-saving operation. The grooves 5314 allow the distance 5311D between the two opposite first surfaces 5311 to be set at least ¼ times the shank diameter 51D, so the strength of the first body 531 is increased. By comparison with the conventional drill 14 of FIG. 1, the material of the first body 531 is not limited. Thus, the selection of the material of this invention is flexible, and the cost of the material is correspondingly reduced.

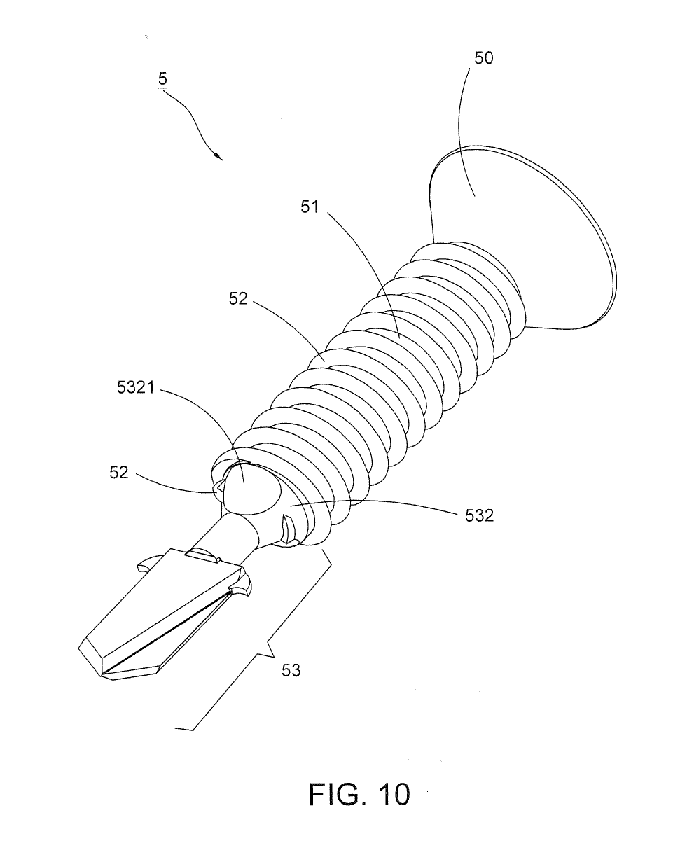

Referring to FIG. 10, a screw 3 of a third preferred embodiment of this invention still comprises a head 50, a shank 51, a threaded section 52 and a drilling portion 53. The concatenation of correlated elements is the same as the first preferred embodiment and herein is omitted. This preferred embodiment is characterized in that the threaded section 52 spirally disposed on the shank 51 further extends to the conical surface of the second body 532. Preferably, the second body 532 can have one or more chip clearance recesses 5321 formed thereon. Accordingly, the extension of the threaded section 52 to the second body 532 helps the drilling action and allows the screw 5 to be straight and smoothly drilled into the workpiece. The chip clearance recess 5321 also helps remove the chips along the second body 532 quickly, thereby increasing the drilling effect and operating more smoothly.

To sum up, this invention takes advantage of the groove formed on each first surface of the first body and extending upwards from the point to set the distance between the two opposite first surfaces at ¼˜¾ times the diameter of the shank, thereby increasing the strength of the first body. The first body having the flat first surface with the groove in cooperation with the second body or in cooperation with the second body and the neck helps increase the space for removing and accommodating the chips. The second body also helps the quick removal of the chips when the chips leave the grooves in order to facilitate a smooth and labor-saving operation.

While the embodiments of this invention are shown and described, it is understood that further variations and modifications may be made without departing from the scope of this invention.

What is claimed is:

1. A screw comprising:
a head;
a shank extending downwards from said head;
a threaded section spirally disposed on said shank; and
a drilling portion connected to said shank, wherein said drilling portion includes a first body having a point and a second body disposed between said first body and said shank, said second body having a shape of a conical frustum, said first body having a flat shape, said first body having two opposite first surfaces which are respectively formed in opposite sides of said first body, two second surfaces extending from said first surfaces respectively, and two third surfaces connected to said first surfaces and said second surfaces and sloping down from said second surfaces to said point respectively, each of said first surfaces being defined by a flat surface, a groove being recessedly formed on each of said first surfaces and extending upwards from said point by an extended length, said groove meeting each of said second surfaces and each of said third surfaces along a cutting edge, a distance between said two opposite first surfaces being ¼˜¾ times a diameter of said shank.

2. The screw as claimed in claim 1, wherein at lease one wing protrudes from said second surface of said first body.

3. The screw as claimed in claim 1, wherein at lease one wing protrudes from said shank.

4. The screw as claimed in claim 1, wherein said threaded section extends to said second body.

5. The screw as claimed in claim 1, wherein at least one chip clearance recess is formed on said second body.

6. The screw as claimed in claim 1, wherein a neck is disposed between said second body and said first body, a maximum diameter of said neck being less than said diameter of said shank.
